(19) United States
(12) Patent Application Publication
(10) Pub. No.: US 2018/0253601 A1
(43) Pub. Date: Sep. 6, 2018

(54) METHOD OF PROVIDING AUGMENTED REALITY CONTENT, AND ELECTRONIC DEVICE AND SYSTEM ADAPTED TO THE METHOD

(71) Applicant: SAMSUNG ELECTRONICS CO., LTD., Suwon-si (KR)

(72) Inventors: Bonhyun KOO, Suwon-si (KR); Jaehong KIM, Yongin-si (KR); Junhyung KIM, Yongin-si (KR); Dusan BAEK, Seoul (KR); Youngkyu KIM, Hwaseong-si (KR); Taewon AHN, Suwon-si (KR)

(21) Appl. No.: 15/913,038

(22) Filed: Mar. 6, 2018

(30) Foreign Application Priority Data
Mar. 6, 2017 (KR) 10-2017-0028082

(51) Int. Cl. G06K 9/00; H04W 4/70; G06T 19/00; H04W 4/02; H04W 12/04

(52) U.S. Cl. CPC G06K 9/00671; H04W 4/70; G06T 19/006; H04B 17/27; H04W 12/04; G06T 2215/16; G06K 2209/40; H04W 4/023

(57) ABSTRACT

The present disclosure relates to a technology related to a Sensor Network, Machine to Machine (M2M), Machine Type Communication (MTC), and Internet of Things (IoT). The present disclosure is applied to intelligent services, based on the technology, for example, smart homes, smart buildings, smart cities, smart cars or connected cars, health care, digital education, retail business, security, safety-related services, or the like. In accordance with an example aspect of the present disclosure, a method of displaying augmented reality content in an electronic device is provided. The method includes: receiving sensor data from a specific sensor node outside the electronic device; obtaining image information from an image taking unit comprising imaging circuitry such as, for example, and without limitation, a camera, camcorder or the like, configured to generate image information; generating augmented reality content based on the sensor data and the image information; and displaying the augmented reality content.

### CROSS-REFERENCE TO RELATED APPLICATION

The present application is based on and claims priority under 35 U.S.C. § 119 to Korean Patent Application No. 10-2017-0028082 filed on Mar. 6, 2017, the content of which is incorporated by reference herein in its entirety.

### BACKGROUND

### 1. Field

The present disclosure relates generally to augmented reality. For example, the present disclosure is related to a method, system and electronic device for providing augmented reality content created based on data received from one or more external sensor nodes.

### 2. Description of Related Art

Internet of Things (IoT) is a technology that enables devices that belong to a single network to connect each other seamlessly. In order to process information exchanged between distributed configurations such as things, the Internet evolves to the IoT network.

In order to provide IoT services, various technical components are required, such as, sensing technology, wired/wireless communication and network infra technology, a service interfacing technology, a security technology, etc. In particular, various technologies combining various types of devices with a single network, e.g., a sensor network for connecting things, Machine to Machine (M2M), Machine Type Communication (MTC), etc., have been researched.

Under the IoT environment, intelligent Internet Technology (IT) services may be provided to collect and analyze data obtained from things connected to each other and thus to create new value for human life. IoT is fused and combined with various industries along with existing information technologies, and thus may be applied within various fields, such as: smart homes, smart buildings, smart cities, smart cars or connected cars, smart grids, health care, smart home appliances, high quality medical services, etc.

In order to receive IoT services, various types of wearable devices are released on the market. A typical example of the wearable device is a smart watch and a Head-Mounted Display (HMD). Examples of the smart watch are Apple iWatch, Samsung Galaxy GearS, etc. Examples of the HMD are Google Glass, and Samsung GearVR.

An example of various IoT service applications using wearable devices is a building management system in a smart building environment, employing a control service using a portable device. For example, in order to manage a building, ambient environment information (e.g., temperature, humidity) may be collected using data obtained from a wireless sensor network including a number of sensor nodes.

Meanwhile, Augmented Reality (AR), as a type of Mixed Reality between reality and virtual reality, is referred to as a technology that blends information or things in the virtual world into the real world, and thus augments the information or things as if they exist in the original environment. To this end, augmented reality recognizes a specific object, generates a 3D image for the recognized object, and overlays a captured image with the generated 3D image. In general, augmented reality technology discovers a location of an object from an image obtained by a camera, using a marker with a specific image or an image pattern, as a reference. Therefore, in order to implement general augmented reality technology, a number of tasks are required, such as a process of constructing an image registration software program for recognizing markers or location information to which information in the real world is blended, a process of previously registering necessary information in a database, a process of linking the registered information to information in the real world, etc.

When Augmented Reality (AR) technology is applied to large-scale space, such as buildings, etc., a general AR scheme, e.g., a marker-based AR scheme, may not be suitable for the space. For example, in order to detect conditions of the temperature, humidity, energy, wires, pipes, etc. at points of a building which are not seen, such as a point behind the ceiling panel, a point behind the wall, the underground, etc., this requires complicated processes such as a process of installing markers to points that are seen, a process of applying an AR technology to points that are not seen, based on the markers at the points that are seen, etc.

### SUMMARY

The present disclosure addresses the problems described above and provides an Augmented Reality (AR) technology using data received from wireless sensor nodes.

In accordance with an example aspect of the present disclosure, a method of displaying augmented reality content in an electronic device is provided. The method includes: receiving sensor data from a specific sensor node outside the electronic device; obtaining image information from an image taking unit comprising imaging circuitry such as, for example, and without limitation, a camera, camcorder or the like, configured to generate image information; generating augmented reality content based on the sensor data and the image information; and displaying the augmented reality content.

The method may further include: receiving an identifier from the specific sensor node for identifying the specific sensor node. The method may further include: determining a location of the specific sensor node based on the identifier. The augmented reality content may be generated based on a sensed value comprising at least one of: a temperature value, a humidity value and an illuminance value at the location.

The method may further include: receiving, from the specific sensor node, information on a location of the specific sensor node. The augmented reality content may be generated based on a sensed value comprising at least one of: a temperature value, a humidity value and an illuminance value at the location. The method may further include: calculating (determining) a location of the electronic device based on strength of signals received from a plurality of wireless sensor nodes including the specific sensor node. At least one of the wireless sensor nodes may be installed at a location that differs from other nodes. The calculation (determination) of the location of the electronic device may include: calculating (determining) a height location of the electronic device.

The augmented reality content may be updated based on the location and the movement of the electronic device.

The generating of the augmented reality content may include: scaling the augmented reality content, based on a distance between the electronic device and the specific sensor node.

The method may further include: requesting the sensor data from the specific sensor node. The request may include identification information of the electronic device, and the sensor data may be received in response to the identification information.

The sensor data may be encoded with a first encryption key. The method may further include: decoding the encoded sensor data using a second encryption key corresponding to the first encryption key.

The method may further include: recognizing the specified sensor node as a marker. The augmented reality content may be generated based on information derived from the sensor data, the image information and the marker.

In accordance with another example aspect of the present disclosure, an electronic device is provided. The electronic device includes: a transceiver configured to receive sensor data from a specific sensor node outside the electronic device; an image taking unit comprising image taking circuitry, such as, for example, and without limitation, a camera, a camcorder, or the like, configured to take images and to generate image information; a processor functionally or operatively connected to the transceiver and the image taking unit; and a display configured to display the augmented reality content. The processor is configured to generate the augmented reality content based on the sensor data and the image information.

The transceiver may be configured to receive, from the specific sensor node, an identifier for identifying the specific sensor node. The processor may be configured to determine a location of the specific sensor node based on the identifier. The processor may be configured to generate the augmented reality content based on a sensed value comprising at least one of: a temperature value, a humidity value and an illuminance value at the location.

The transceiver may be configured to receive, from the specific sensor node, information on a location of the specific sensor node. The processor may be configured to generate the augmented reality content based on a sensed value comprising at least one of: a temperature value, a humidity value and an illuminance value at the location.

The processor may be configured to calculate (determine) a location of the electronic device based on strength of signals received from a plurality of wireless sensor nodes including the specific sensor node. At least one of the wireless sensor nodes may be installed at a location that differs from other nodes. The processor may be configured to calculate (determine) a height location of the electronic device.

The processor may be configured to update the augmented reality content based on the location and the movement of the electronic device.

The processor may be configured to scale the augmented reality content, based on a distance between the electronic device and the specific sensor node. The processor may be configured to request the sensor data from the specific sensor node. The request may comprise identification information of the electronic device. The sensor data may be received in response to the identification information.

The sensor data may be encoded with a first encryption key. The processor decodes the encoded sensor data using a second encryption key corresponding to the first encryption key.

The image taking unit may be configured to recognize the specific sensor node as a marker. The processor may be configured to generate the augmented reality content, based on information derived from the sensor data, the image information and the marker.

In accordance with another example aspect of the present disclosure, a method of a wireless sensor node for transmitting sensor data is provided. The method includes: generating sensor data by performing a measurement using a sensor; receiving, from an electronic device, a request for sensor data including the sensed data; encoding the sensor data; and transmitting the encoded sensor data to the electronic device.

The request may include identification information of the electronic device. Encoding the sensor data may include encoding the sensor data using an encryption key corresponding to the identification information.

The method may further include transmitting identification information on the wireless sensor node to the electronic device.

The method may further include transmitting location information of the wireless sensor node to the electronic device.

The sensed data may include at least one of a temperature value or a humidity value.

The method may further include: identifying states of another sensor node communicating with the wireless sensor node; and transmitting a report on the states of the other sensor node to the electronic device. Identifying states of another sensor node may include: determining whether the other sensor node works normally; and identifying, if the other sensor node does not work normally, a cause generating a malfunction of the other sensor node. The report may include a value indicating the cause. Identifying states of another sensor node may include: determining whether the other sensor node works normally. The report may include location information or an identifier of the other sensor node that does not work normally.

In accordance with another example aspect of the present disclosure, a wireless sensor node is provided. The wireless sensor node may include: a sensor configured to perform a measurement and to generate sensor data; a communication unit comprising communication circuitry configured to receive, from an electronic device, a request for sensor data including the sensed data; and a processor configured to encode the sensor data. The communication unit may be configured to transmit the encoded sensor data to the electronic device.

The request may include identification information of the electronic device. The processor may be configured to encode the sensor data using an encryption key corresponding to the identification information.

The communication unit may be configured to transmit identification information of the wireless sensor node to the electronic device.

The communication unit may be configured to transmit sensor data including location information of the wireless sensor node to the electronic device.

The sensed data may include at least one of a temperature value or a humidity value.

The processor may be configured to identify states of another sensor node communicating with the wireless sensor node. The communication unit may be configured to transmit a report on the states of the other sensor node to the electronic device. The processor may be configured to determine whether the other sensor node works normally; and to identify, if the other sensor node does not work normally, a cause generating a malfunction of the other sensor node. The report may include a value indicating the cause. The processor may be configured to determine whether the other sensor node works normally. The report may include location information or an identifier of the other sensor node that does not work normally.

### BRIEF DESCRIPTION OF THE DRAWINGS

The above and other aspects, features and attendant advantages of the present disclosure will be more apparent and readily appreciated from the following detailed description, taken in conjunction with the accompanying drawings, in which like reference numerals refer to like elements, and wherein:

FIG. 1 are diagrams illustrating example marker-based AR technologies;

FIG. 2A is a diagram illustrating an example procedure of processing data by a marker-based AR technology;

FIG. 2B is a diagram illustrating an example procedure of processing data by a wireless sensor node-based AR technology according to an example embodiment of the present disclosure;

FIG. 3 is a diagram illustrating an example wearable device and wireless sensor nodes which perform the 3D visualization of ambient sensor data measured by the wireless sensor nodes according to an example embodiment of the present disclosure;

FIG. 4 is a flowchart illustrating an example method of visualizing node/sensor information according to an example embodiment of the present disclosure;

FIG. 5 is a diagram illustrating an example data frame structure for communication with an electronic device to provide AR content from wireless sensor nodes according to an example embodiment of the present disclosure;

FIG. 6 is a diagram illustrating an example method of determining a location of an electronic device using three wireless sensor nodes according to an example embodiment of the present disclosure;

FIGS. 7 and 8 are diagrams illustrating an example method of determining a location of an electronic device using four wireless sensor nodes according to an example embodiment of the present disclosure;

FIG. 9 is a diagram illustrating an example determination of a rotation direction of an electronic device using head tracking according to an example embodiment of the present disclosure;

FIGS. 10 and 11 are diagrams illustrating example operations of a plurality of wireless sensor nodes and an electronic device according to an example embodiment of the present disclosure;

FIG. 12 is a flowchart illustrating an example method of displaying augmented reality content according to an example embodiment of the present disclosure;

FIG. 13 is a diagram illustrating example augmented reality content generated according to an example embodiment of the present disclosure;

FIG. 14 is a flowchart illustrating an example method for transmitting sensor data according to an example embodiment of the present disclosure;

FIG. 15 is a block diagram illustrating an example configuration of an electronic device for providing AR content according to an example embodiment of the present disclosure; and

FIG. 16 is a block diagram illustrating an example configuration of a wireless sensor node according to an example embodiment of the present disclosure.

### DETAILED DESCRIPTION

It should be understood that the various example embodiments of the present disclosure described herein may be altered, changed or modified in various ways, to include various modification, equivalents and/or alternatives. Example embodiments are illustrated in the drawings and described in greater detail in the description. However, this is not intended to limit the disclosure to particular modes of practice, and it should be understood that all changes, equivalents, and substitutes that do not depart from the spirit and technical scope of the disclosure are encompassed in the disclosure. Detailed descriptions of well-known functions and structures incorporated herein may be omitted to avoid obscuring the subject matter of the disclosure.

The terms such as “first” and “second” are used herein merely to describe a variety of elements, but the elements are not limited by the terms. The terms are used only for the purpose of distinguishing one element from another element.

The terms used in the present disclosure are used for explaining a specific embodiment and do not limit the scope of the disclosure. Thus, the expression of singularity in the present disclosure includes the expression of plurality unless clearly specified otherwise. Also, the terms such as “include” or “comprise” may be understood to denote a certain feature, number, step, operation, element, component or a combination thereof, but may not be understood to exclude the existence of or a possibility of addition of one or more other features, numbers, steps, operations, elements, components or combinations thereof.

In the example embodiments, a ‘module’ or ‘unit’ performs at least one function or operation and may be implemented with hardware, software, or a combination thereof. A number of modules or a number of units, except for a ‘module’ or a ‘unit’ which needs to be implemented with specific hardware, may be implemented in such a way that they are integrated into at least one module as at least one processor (not shown).

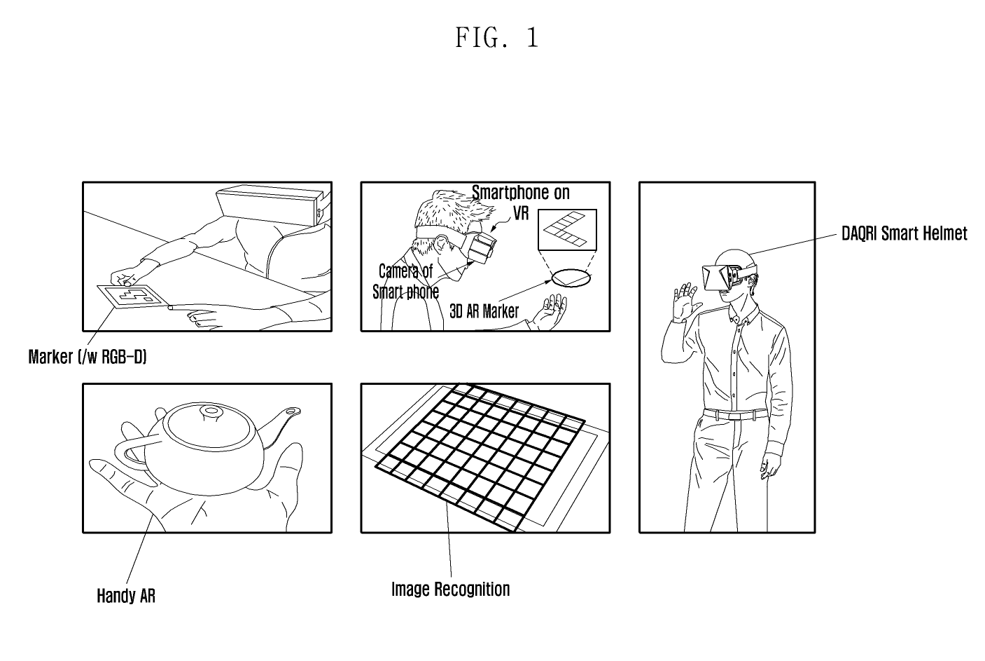

FIG. 1 includes diagrams illustrating example marker-based AR technologies. A marker-based AR technology recognizes real information in such a way as to overlay it with virtual information via a specific marker which can be recognized by, for example, a camera, and thus does not cause an separation or division between the real information and the virtual information. Marker-based augmented reality technologies may refer, for example, to markers with a unique black and white image or pattern. As illustrated in FIG. 1, various markers (e.g., RGB-D marker, 3D AR marker, or the like) may be used. Examples of the marker-based augmented reality technology are Handy AR, Image Recognition, DAQRI smart helmet, or the like, but is not limited thereto.

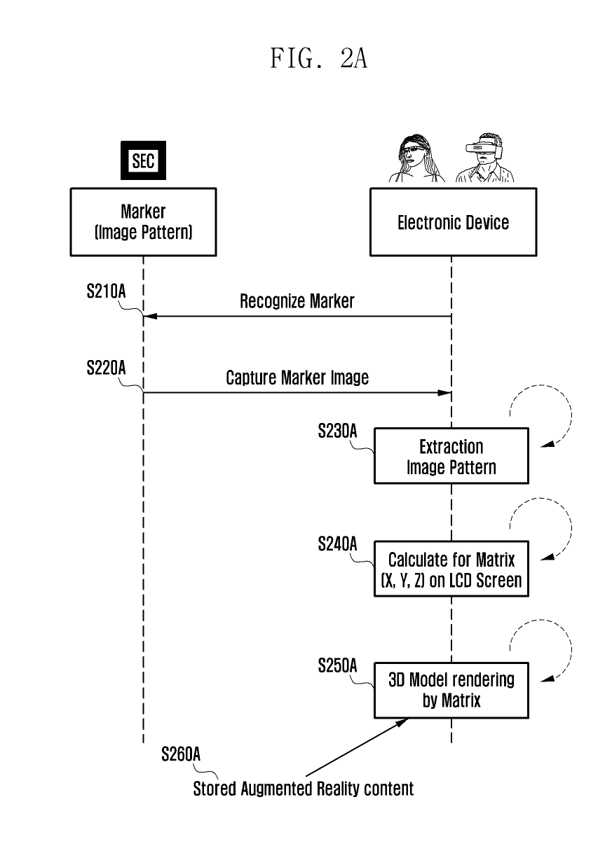

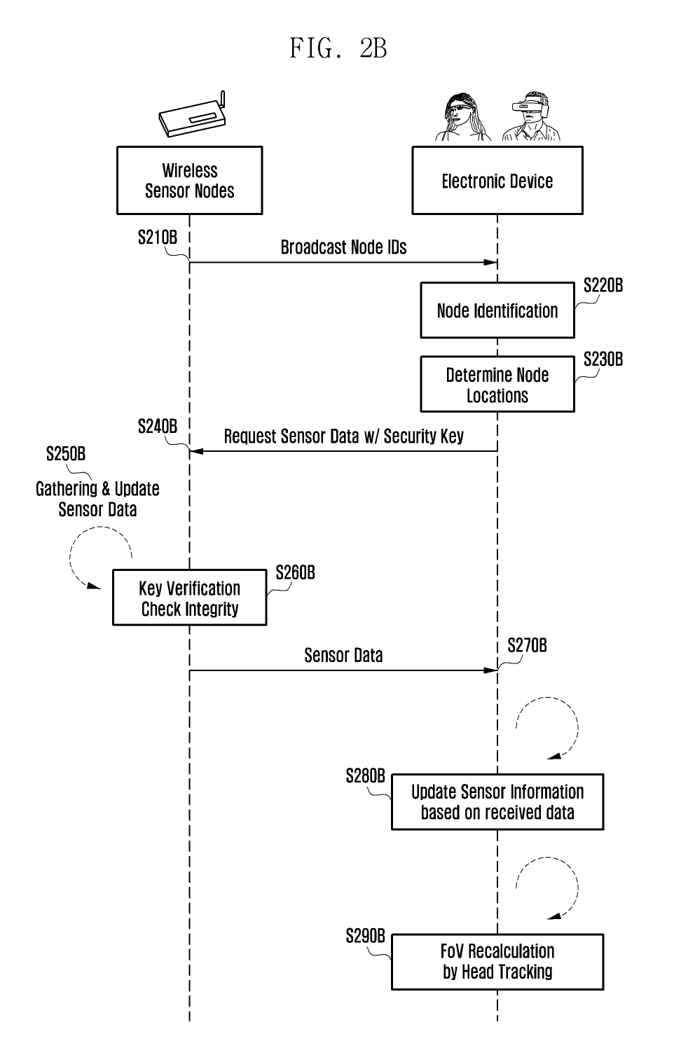

FIG. 2A is a diagram illustrating an example procedure of processing data by a marker-based AR technology. FIG. 2B is a diagram illustrating an example procedure of processing data by a wireless sensor node-based AR technology according to an example embodiment of the present disclosure.

With reference to FIG. 2A, the marker-based AR technology identifies a pattern of a marker pattern, and visualizes a stored image or animation. For example, the marker-based AR technology enables an electronic device for providing AR content to recognize a marker (S210A), and performs the visualization by projecting a 3D object image on a captured image, based on a recognized marker (S220A). That is, the device projects a marker and captures a marker image, using an image taking unit (e.g., camera).

The device extracts an image pattern (S230A). For example, if an image captured in operation S220A is an image of a red/green/blue (RGB) format, the device converts the image of an RGB format into a gray scale image, and then to a binary image. Part of the binary image generated by the binary image process may be an image of interest for the image process. In addition, the binary image may be further processed in such a way that parts of the area, which can be considered as clusters, are grouped. After that, a contour detect procedure for extracting the contours of the grouped parts, a vertex detect procedure for detecting vertexes of the contours to identify the rectangle area by pattern markers, and a normalization procedure for forming, from the contours identified as a rectangular area, a square with four congruent sides and four 90° angles are performed. Therefore, a code, identical to the code detected from a rectangular area when a pattern marker is first registered, may be extracted as a pattern code.

A location matrix (X, Y, Z) is calculated on the LCD screen (S240A). 3D model rendering by matrix is performed (S250A). Stored augmented reality content is loaded (S260A).

Meanwhile, the marker-based AR technology has a disadvantage because the augmented reality information is implemented only if it correctly recognizes the markers. If a marker is lost or the camera angle is not correct, the technology has difficulty in implementing content. As described above, when Augmented Reality (AR) technology is applied to large-scale space, such as buildings, etc., a marker-based AR scheme may not be suitable for the space. For example, in order to detect conditions of temperature, humidity, energy, wires, pipes, etc. at points of a building which are not seen (or visible), such as a point behind the ceiling panel, a point behind the wall, underground, etc., this requires complicated processes such as a process of installing markers to points that are seen (visible), a process of applying an AR technology to points that are not seen, based on the markers at the points that are seen, etc.

On the other hand, as illustrated in FIG. 2B, according to the wireless sensor node-based AR technology of the present disclosure, a wireless sensor node is capable of serving as a marker, and receiving data sensed and measured by a sensor, information on a location of a wireless sensor node, etc. from a wireless sensor node. For example, wireless sensor nodes broadcast their IDs (S210B). An electronic device for providing AR content is capable of identifying wireless sensor nodes based on received IDs (S220B), and calculating (determining) locations of wireless sensor nodes (S230B). In this case, in order to perform more precise determination, a process for removing noise from an RF signal (not shown) received from a wireless sensor node may be further performed.

Meanwhile, a marker-based AR technology may enable, if a camera is located on a pattern set by the camera, anybody to load data and apply the visualization process to the data. However, a wireless sensor node AR technology enables only a specific user with permitted authority (e.g., key information), e.g., a manager of a building, etc., to permit the access to the data and information, thereby blocking the access to sensitive information regarding pipe/electricity/energy data information, etc.

For example, with reference to FIG. 2B, the electronic device is capable of transmitting a request of sensor data including Security Key to a wireless sensor node (S240B), and gathering and updating sensor data (S250B). The wireless sensor node is capable of performing Key Verification Check Integrity (S260B), and transmitting the sensor data in response to the request (S240B) to the electronic device (S270B). The electronic device is capable of updating sensor information based on the received data (S280B), and re-calculating FoV by the head tracking (S290B).

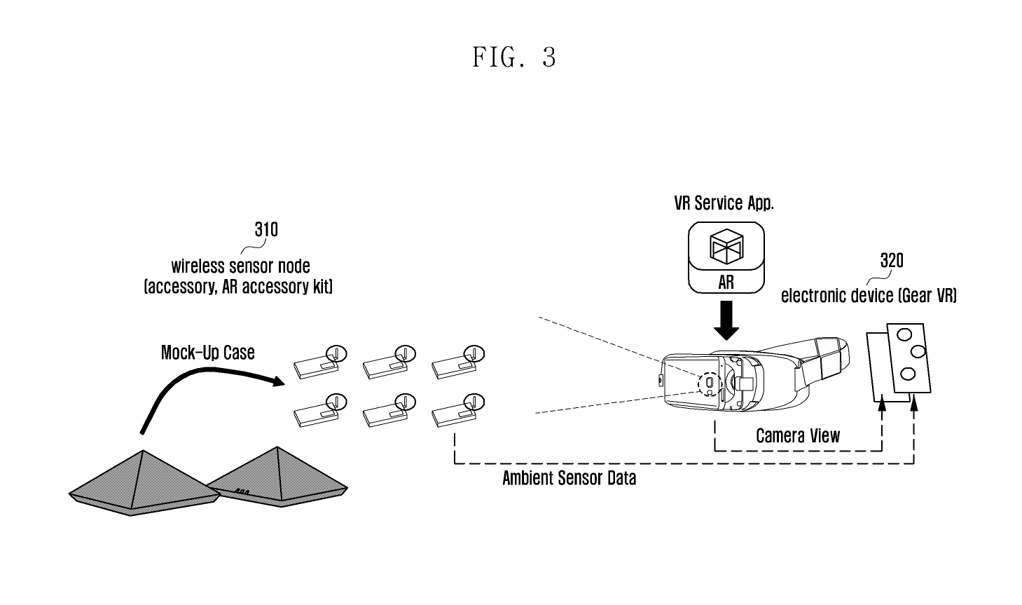

FIG. 3 is a diagram illustrating an example wearable device and wireless sensor nodes which perform the 3D visualization of ambient sensor data measured by the wireless sensor nodes according to an example embodiment of the present disclosure.

As illustrated in FIG. 3, a system for 3D visualization of sensed data measured by wireless sensor nodes, according to an example embodiment of the present disclosure, is capable of including: wireless sensor nodes 310 for measuring ambient information and generating sensed data, such as accessories for AR; and a wearable device 320 (e.g., gear VR) that receives sensed data, radio frequency (RF) information (e.g., control information), application information, etc. from the wireless sensor nodes 310, and processes the received result with visualization. The wireless sensor node 310, disposed outside the wearable device 320, may be implemented to include a node for performing communication and a sensor for sensing ambient information, which are formed: as separate objects (mock-up cases), respectively; or a single object (a mock-up case). In the following description, the wireless sensor node is referred to as an object including a sensor and a node.

Meanwhile, as described above, an existing marker-based AR technology requires processes of extracting a unique image pattern from a marker, and calculating a location matrix for the extracted result. In addition, the additionally visualized images are limited to images, animation effects, etc. which are stored in an electronic device. However, according to a system for providing augmented reality content according to various example embodiments of the present disclosure, wireless sensor nodes provide sensed data measured by wireless sensor nodes, radio frequency (RF) information (e.g., control information), application information, etc., for existing marker function and additional functions, and an electronic device displays augmented reality content, considering the information described above.

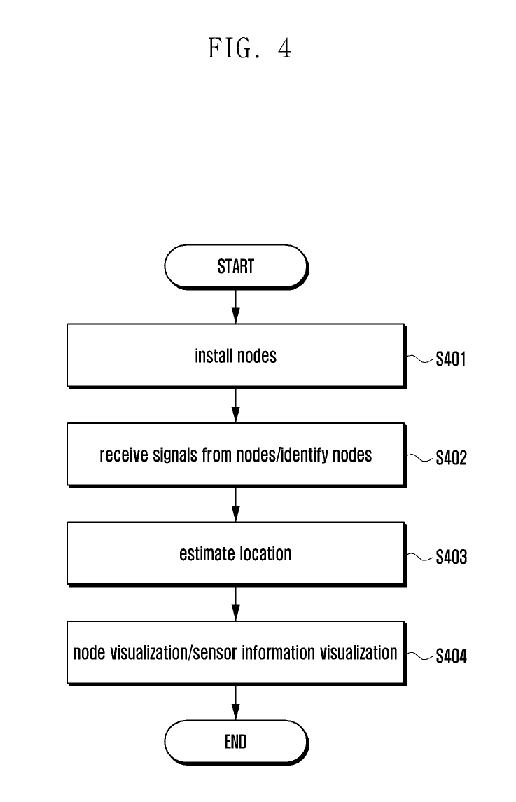

FIG. 4 is a flowchart illustrating an example method of visualizing node/sensor information according to an example embodiment of the present disclosure.

With reference to FIG. 4, wireless sensor nodes are installed, for example, in a building (S401). Installation locations of wireless sensor nodes may be databased and stored in electronic devices for providing AR content, etc. Each of the wireless sensor nodes transmits RF signals periodically or aperiodically. For example, wireless sensor nodes may advertise or broadcast their IDs. Wireless sensor nodes may transmit a reference signal to measure received signal strength indication (RSSI).

When an electronic device moves in the vicinity of a wireless sensor node, it receives a signal from the wireless sensor node and identifies the wireless sensor node, based, for example, on RSSI of the reference signal and/or the ID of the wireless sensor node included in the received signal (S402).

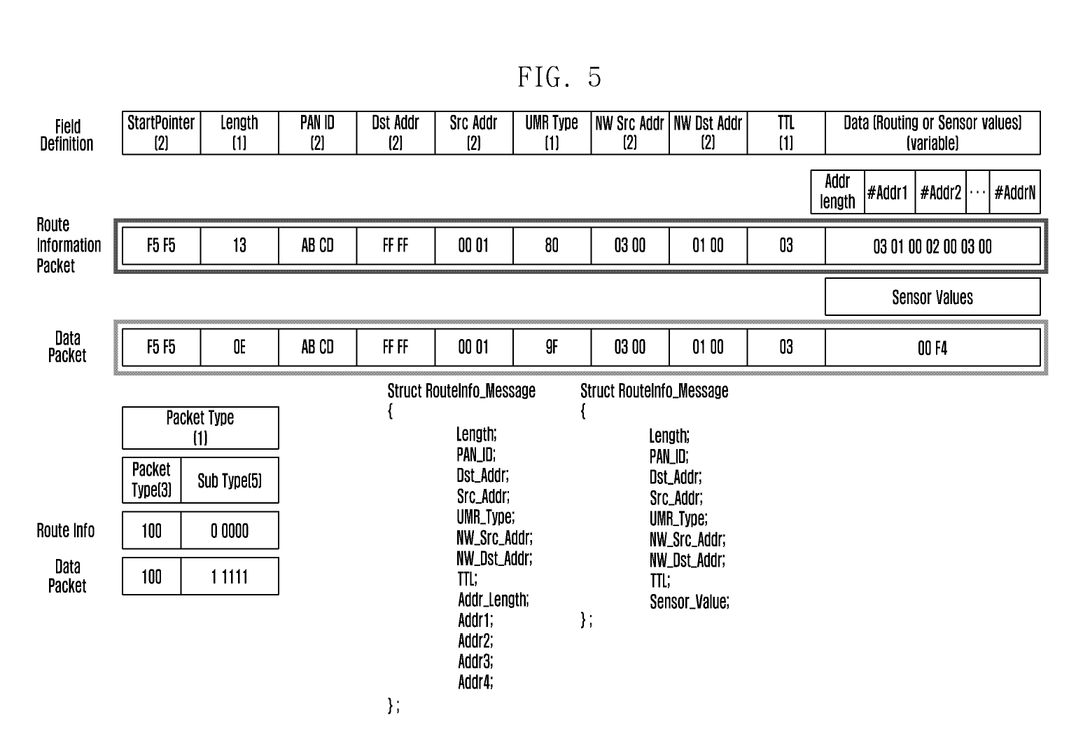

FIG. 5 is a diagram illustrating an example data frame structure for communication with an electronic device to provide AR content from wireless sensor nodes according to an example embodiment of the present disclosure.

Each of the wireless sensor nodes may use data in the frame structure illustrated in FIG. 5 to transmit information and sensed data of nodes. For example, a source address field of 2 bytes, Src Addr, is extracted from the frame structure, as illustrated in FIG. 5, and used as an ID of the wireless sensor node. Data packets are identified by a type of user measurement report (UMR) and a data field. For example, it is determined whether the data packets are sensed data. Sensor data received from a wireless sensor node includes data regarding the temperature or humidity measured by a wireless sensor node, and underlies augmented reality content for the display.

With reference back to FIG. 4, a procedure for estimating locations of wireless sensor nodes and/or an electronic device is performed (S403). For example, in order to obtain information on a location of a wireless sensor node, an electronic device receives an ID from the wireless sensor node, and determines a location of the wireless sensor node, based on the received ID and a location of the wireless sensor node stored in the database. Alternatively, the electronic device may directly receive information on a location of a wireless sensor node from the wireless sensor node.

As another example, information on a location of an electronic device may be derived based on the strength of signal (e.g., RSSI) received from a plurality of wireless sensor nodes. For example, three may be selected among the plurality of wireless sensor nodes in order of strongest signal strength, and then a location of an electronic device may be calculated (determined) based on the strength of signals received by the selected wireless sensor nodes.

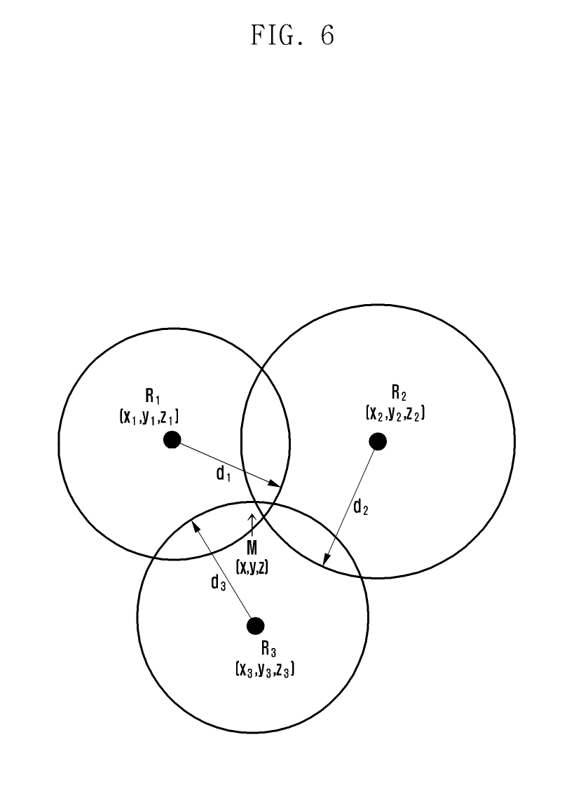

FIG. 6 is a diagram illustrating an example method of calculating (determining) a location of an electronic device using three wireless sensor nodes according to an example embodiment of the present disclosure.

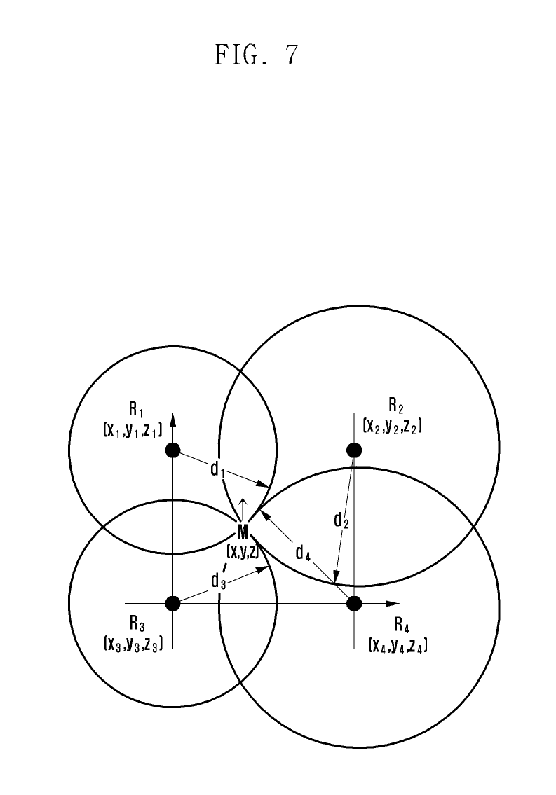

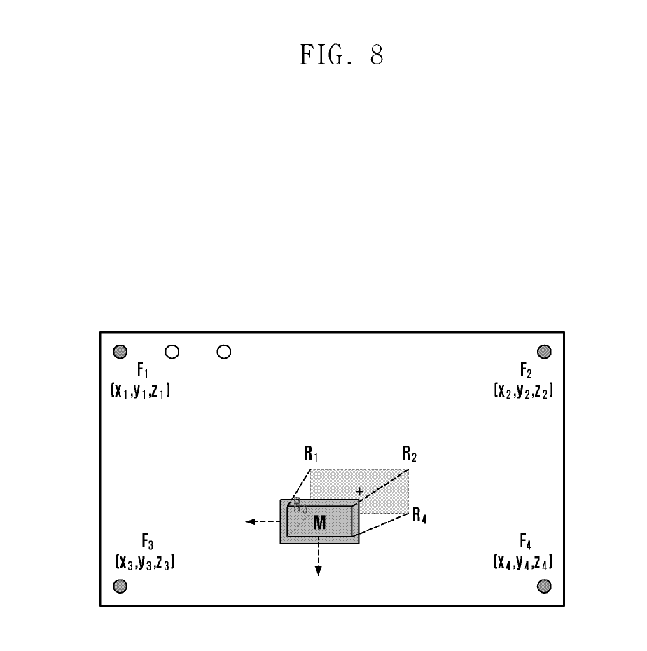

Referring to FIG. 6, the wireless sensor nodes R₁, R₂ and R₃ are located at [x₁, y₁, z₁], [x₂, y₂, z₂] and [x₃, y₃, z₃], respectively. The location of the electronic device M (e.g., [x, y, z]) can be calculated (determined) based on distances between the electronic device M and the wireless sensor nodes R₁, R₂ and R₃ (e.g., d₁, d₂ and d₃). The distances d₁, d₂ and d₃ are determined based on the strength of signals (e.g., RSSI) received from the wireless sensor nodes R₁, R₂ and R₃. For example, the location of the electronic device M (e.g., [x, y, z]) can be determined as the vicinity of the overlap between points apart from the wireless sensor nodes R₁ by d₁ (e.g., the circle the center of which is R₁ in FIG. 6), points apart from the wireless sensor nodes R₂ by d₂ (e.g., the circle the center of which is R₂ in FIG. 6) and points apart from the wireless sensor nodes R₃ by d₃ (e.g., the circle the center of which is R₃ in FIG. 6). Meanwhile, Global Positioning System (GPS), as a generally used technology for recognizing location information, has a problem in accuracy, and is difficult to provide an accurate AR service since GPS has an error of up to 20 m from a real location. That is, GPS does not precisely indicate a real location while providing a destination search service, etc., which is one of the factors decreasing the usability of GPS. Since GPS uses satellite signals, it can only detect a location on the plane in the map but cannot recognize the height of on object, such as a location in a building, etc. Therefore, GPS has a limit to provide a location information service. In order to address the problem, according to various example embodiments of the present disclosure it is possible to use four or more wireless sensor nodes to calculate a location including the height of the location (e.g., which floor within a building) in which an electronic device is located, e.g., a z-coordinate value in the Cartesian coordination. In this example, at least one of the four or more wireless sensor nodes should be installed to a location that differs in height from the location of the other nodes. FIGS. 7 and 8 describe a method of calculating a location of an electronic device using four wireless sensor nodes. Similar to the example method illustrated in FIG. 6, the location of the electronic device M (e.g., [x, y, z]) in FIGS. 7 and 8 can be calculated (determined) based on distances between the electronic device M and the wireless sensor nodes.

Referring to FIG. 7, the wireless sensor nodes R₁, R₂, R₃ and R₄ are located at [x₁, y₁, z₁], [x₂, y₂, z₂], [x₃, y₃, z₃] and [x₄, y₄, z₄], respectively. Referring to FIG. 8, the wireless sensor nodes F₁, F₂, F₃ and F₄ are located at [x₁, y₁, z₁], [x₂, y₂, z₂], [x₃, y₃, z₃] and [x₄, y₄, z₄], respectively. The wireless sensor nodes F₁, F₂, F₃ and F₄ in FIG. 8 may be installed to fixed points, and correspond to the wireless sensor nodes R₁, R₂, R₃ and R₄ in FIG. 7. The wireless sensor nodes R₁, R₂, R₃ and R₄ in FIG. 7 may be installed on different floors, e.g., F₁, F₂, F₃ and F₄ as illustrated in FIG. 8.

The location of the electronic device M (e.g., [x, y, z]) in FIGS. 7 and 8 can be calculated (determined) based on distances between the electronic device M and the wireless sensor nodes R₁, R₂, R₃ and R₄ (e.g., d₁, d₂, d₃ and d₄). The distances d₁, d₂, d₃ and d₄ are determined based on the strength of signals (e.g., RSSI) received from the wireless sensor nodes R₁, R₂, R₃ and R₄. For example, the location of the electronic device M (e.g., [x, y, z]) can be determined as the vicinity of the overlap between points apart from the wireless sensor nodes R₁ by d₁ (e.g., the circle the center of which is R₁ in FIG. 7), points apart from the wireless sensor nodes R₂ by d₂ (e.g., the circle the center of which is R₂ in FIG. 7), points apart from the wireless sensor nodes R₃ by d₃ (e.g., the circle the center of which is R₃ in FIG. 7) and points apart from the wireless sensor nodes R₄ by d₄ (e.g., the circle the center of which is R₄ in FIG. 6).

The location of an electronic device may, for example, be calculated using the following equations.

$$\begin{matrix}\begin{matrix}{d}_{1}^{2} = {( x - {x}_{1} )}^{2} + {( y - {y}_{1} )}^{2} + {( z - {z}_{1} )}^{2} \\ {d}_{2}^{2} = {( x - {x}_{2} )}^{2} + {( y - {y}_{2} )}^{2} + {( z - {z}_{2} )}^{2} \\ ⋮ \\ {d}_{i}^{2} = {( x - {x}_{i} )}^{2} + {( y - {y}_{i} )}^{2} + {( z - {z}_{i} )}^{2} ( i = 0 , 1 , 2 , … , m - 1 )\end{matrix} & [ Equation 1 ] \\ PathLoss ( L ) = 20 {log}_{10} ( \frac{4 π d}{λ} ) \vert dB \vert , \\ where \{ \begin{matrix}d = distance \\ λ = wavelength\end{matrix} \\ d = \frac{λ}{4 π} \cdot {10}^{\frac{L}{20}} = \frac{c}{4 π f} \cdot {10}^{\frac{L}{20}} & [ Equation 2 ]\end{matrix}$$

In order to more precisely estimate locations of wireless sensor nodes and/or electronic device as in S403 of FIG. 4, a process of removing noise from an RF signal received from a wireless sensor node may be additionally performed.

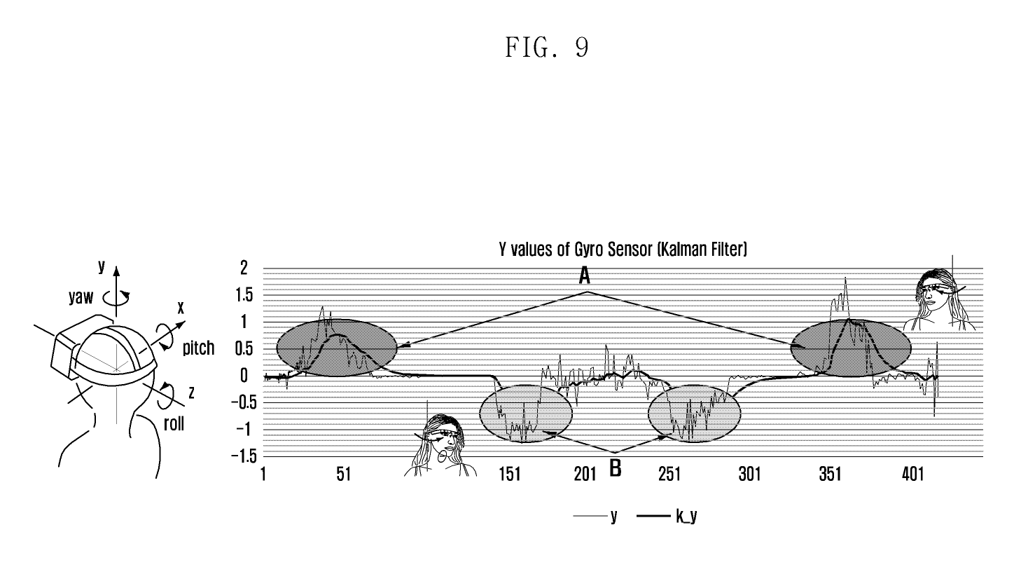

The electronic device performs a process for the visualization of sensor information and a wireless sensor node (S404). For example, if a specific wireless sensor node is at a location corresponding to a display area of an electronic device (e.g., an image/photograph of an actual event), it makes a request for sensed data (e.g., temperature, humidity), based on a distance between the wireless sensor node and the electronic device and/or an ID of the wireless sensor node (which may be obtained by the advertisement and/or broadcast of the wireless sensor node), receives sensor data in response to the request, and visualizes and displays the received sensor data in 3D image. The electronic device is capable of calculating a size of an area to be displayed to scale. For example, the scaling factor may be determined, using d in [Equation 2]. Therefore, according to the correct locations of wireless sensor nodes and the distance from the user, augmented reality content may be rendered/expressed in realistic size. Meanwhile, augmented reality content generated in S404 of FIG. 4 may be updated based on the motion and location of the electronic device. For example, if the electronic device is a Head-Mounted Display (HMD), and the Field of View (FoV) of the electronic device is changed as the electronic device user turns his/her head, the rotation direction and the movement of the electronic device may be calculated based on a rotation value obtained by an application sensor of the electronic device (e.g., an acceleration sensor/angular velocity sensor/gyroscope), and a process of generating augmented reality content based on the location may re-performed. Alternatively, the rotation direction of the electronic device may be calculated by tracking the user's sightline. FIG. 9 describes the calculation of a rotation direction of an electronic device using the head tracking. In order to identify a wireless sensor node that the user looks at, the rotation direction of the electronic device may be calculated, using tables 1 and 2 as follows.

TABLE 1

| Head Movement | Sensor Value (Y) | Camera Angle | API |
|---|---|---|---|
| Right way | 0.00~+1.00 | 0°~+90° | 1, 0 |
| Left way | −1.00~0.00 | −90°~0° | −1, 0 |

TABLE 2

| Head Movement | Sensor Value (Y) | Camera Angle | API |
|---|---|---|---|
| Right way | 0.00~+1.00 | 0°~+30° | 0, 1 |
| Left way | −1.00~0.00 | −30°~0° | 0, −1 |

Meanwhile, at least one filter may be used to remove noise from values of sensors. For example, Kalman filter is applied to values of a gyroscope in Case A of FIG. 9. Compared to Case B where no filter is applied, noise is removed such that the values in Case A are smoothed. In addition, Equation 3 may be used to derive sensor values corrected by using a filter.

$$X = X + ( {SensorValue}_{t} - X ) \times K \\ K = \frac{P + Q}{P + Q + R} P = \frac{R \times ( P + Q )}{R + P + Q} \qquad [ Equation 3 ]$$

In Equation 3, X denotes a corrected SensorValueₜ value (using a filter). SensorValueₜ is a raw data value of sensor data measured at time t. K denotes a system measurement vector at time t. P denotes a processing noise value at time t. Q denotes algorithm definition constant (a pre-defined value). R denotes an estimation noise value at time t. An averaging filter as one of the smoothing filters may be used. In this case, the average is obtained based on the total data. Therefore, as the value is accumulated, the change in the recent value is buried into the average, which is a problem. Therefore, a filter (e.g., Kalman filter) may be used to: smooth by covering the most recently measured samples with a window; and apply the change in the recent RSSI value as it is.

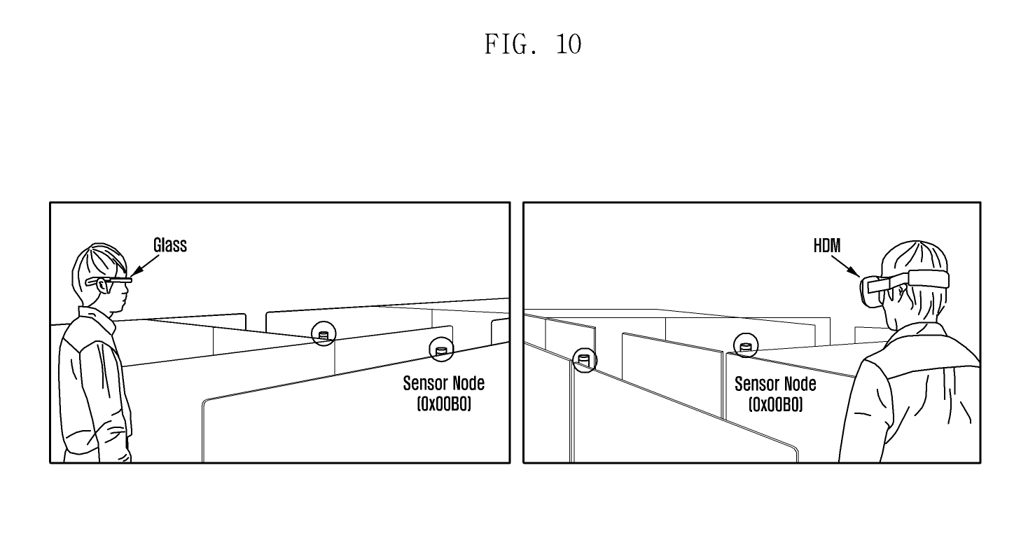

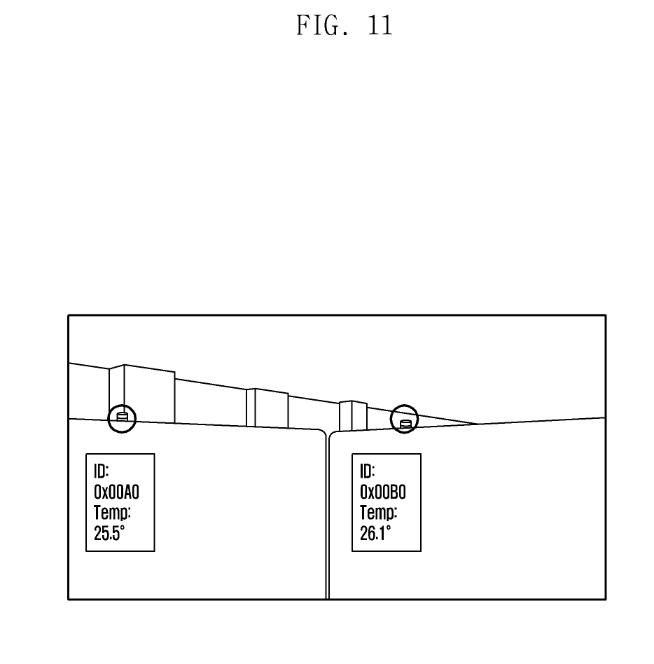

FIGS. 10 and 11 are diagrams illustrating example operations of a plurality of wireless sensor nodes and an electronic device according to an example embodiment of the present disclosure. An electronic device receives information (e.g., information on a wireless sensor node, sensed data measured by a wireless sensor node, etc.) from a plurality of wireless sensor nodes, and shows the information with visualization. With reference to FIG. 10, the electronic device, such as glass or HDM, is capable of receiving sensed data from a sensor node (0x00B0). Therefore, as illustrated in FIG. 11, the temperatures (25.5°, 26.1°) measured by individual sensor nodes (0x00A0, 0x00B0) are displayed on the electronic device.

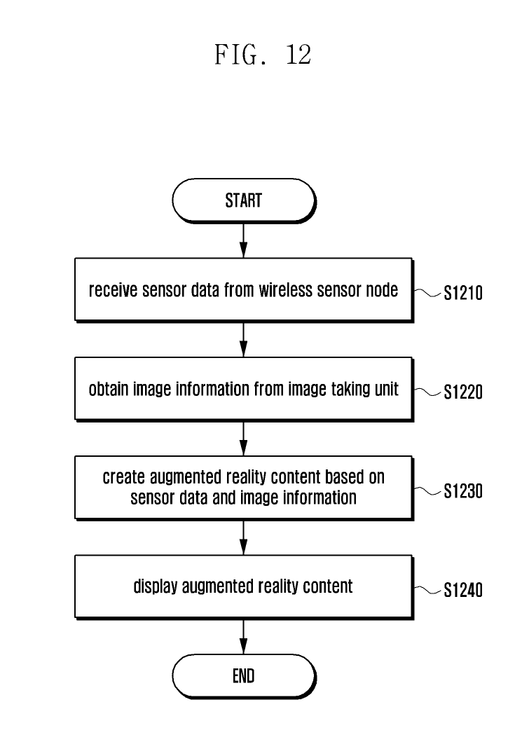

FIG. 12 is a flowchart illustrating an example method of operating/controlling an electronic device for displaying augmented reality content according to an example embodiment of the present disclosure.

With reference to FIG. 12, an electronic device receives sensor data from a wireless sensor node in operation S1210. The sensor data may be referred to as: a sensed value measured by the wireless sensor node (e.g., temperature, humidity, illuminance); information on a wireless sensor node (e.g., an identifier of a wireless sensor node, location information on a wireless sensor node); or application information provided by a wireless sensor node (e.g., information on an ambient sensor node, a location of an ambient sensor node). For example, the electronic device is capable of receiving, from a wireless sensor node: a sensed value measured by a wireless sensor node; information on a wireless sensor node; application information provided by a wireless sensor node; etc. For example, if an electronic device receives an identifier for identifying a wireless sensor node, as information on a wireless sensor node, it is capable of determining a location of the wireless sensor node, based on the received identifier. Alternatively, a location of a wireless sensor node as information on the wireless sensor node may be directly signaled. Sensor data received from a wireless sensor node may be encoded. For example, in a state where a wireless sensor node and an electronic device share a secret key with each other, if the wireless sensor node encodes sensor data using the secret key, and transmits the encoded sensor data to the electronic device, the electronic device is capable of decoding the received encoded sensor data, using the secret key. Alternatively, if the wireless sensor node has a first encryption key and the electronic device has a second encryption key corresponding to the first encryption key, the wireless sensor node encodes sensor data using the first encryption key, and transmits the encoded sensor data to the electronic device. The electronic device is capable of decoding the received encoded sensor data, using the second encryption key. For example, the first encryption key and the second encryption key are a public key and a private key, respectively.

The electronic device is capable of requesting sensor data from a wireless sensor node. The request may include authentication information such as identification information on a wireless sensor node and/or an electronic device, and a secure key. The wireless sensor node is capable of transmitting sensor data to an electronic device only if the electronic device has been authenticated.

The electronic device is capable of calculating (determining) its location based on the strength of signals received from a plurality of wireless sensor nodes. As described above, the electronic device is capable of using four or more wireless sensor nodes to calculate the height of a location where the electronic device is located, e.g., a z-coordinate value in the Cartesian coordination. As described above, according to an example embodiment at least one of the four or more wireless sensor nodes should be installed to a location that differs in height from the location of the other nodes.

In addition, a wireless sensor node has functions as a marker. An electronic device is capable of performing the reception of sensor information from a wireless sensor node and the recognition of a wireless sensor node as a marker, together or separately. If the electronic device recognizes a wireless sensor node as a marker, it is capable of processing provided augmented reality content differently. For example, if the electronic device receives only sensor information, it is capable of providing first information such as a malfunction occurrence guide. If the electronic device recognizes a wireless sensor node as a marker, it is capable of providing second information such as a malfunction repair/restoration guide. In this case, the second information may be generated based on information derived from the recognized marker.

In operation S1220, the electronic device obtains image information from an image taking unit, e.g., a camera, a camcorder, or the like. The image information is referred to as a real image such as a picture or a moving picture, taken by an image taking unit, e.g., a camera, a camcorder, etc. It should be understood that the image information may also be a virtual image where example embodiments of the present disclosure are applied to mixed reality.

In operation S1230, the electronic device generates augmented reality content based on the sensor data received as in operation S1210 and the image information obtained as in operation S1220. For example, the augmented reality content may be generated based on sensed values measured by a wireless sensor node, such as temperature, humidity and/or illuminance.

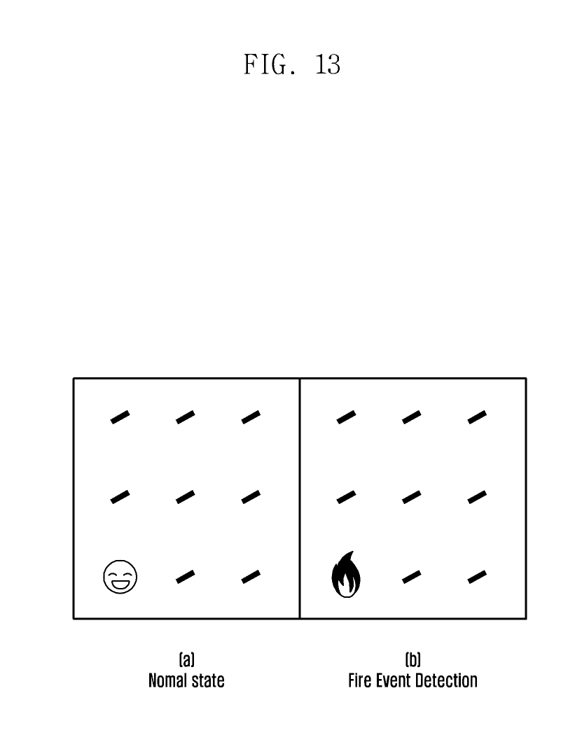

FIG. 13 is a diagram illustrating example augmented reality content generated according to an example embodiment of the present disclosure. With reference to FIG. 13, augmented reality content is provided differently, depending on conditions, according to received content of dynamic data (e.g., real-time sensor data), not existing 1:1 mapping static data. For example, if sensed temperature in a particular area is 20° C. (normal state as shown in diagram (a) of FIG. 13), a smile icon may be displayed. If sensed temperature in a particular area is 80° C., a fire risk icon may be displayed (fire event detection as shown in diagram (b) of FIG. 13).

In operation S1240, the electronic device displays the augmented reality content generated as in operation S1230.

The displayed, augmented reality content may be updated based on the movement and the location of the electronic device, repeating operations from S1210 to S1240.

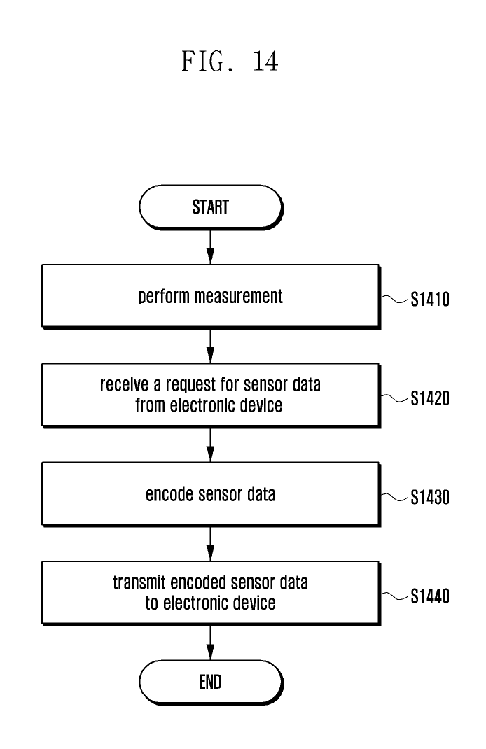

FIG. 14 is a flowchart illustrating an example method of a wireless sensor node for transmitting sensor data according to an example embodiment of the present disclosure. With reference to FIG. 14, a wireless sensor node is capable of performing a method corresponding to the method of the electronic device according to the embodiment illustrated in FIG. 12.

In operation S1410, a wireless sensor node performs a measurement using sensors and generates sensed data. For example, the sensed data may include at least one of: temperature, humidity and illuminance.

In operation S1420, the wireless sensor node receives, from the electronic device, a request for sensor data including sensed data. As described above, the request may include authentication information such as a secure key, identifiers of a wireless sensor node and/or an electronic device, etc. The wireless sensor node may transmit sensor data to an electronic device only if the electronic device has been authenticated.

In operation S1430, the wireless sensor node encodes the sensor data generated as in operation S1410. The wireless sensor node may encode the sensor data, using an encryption key corresponding to authentication information on an electronic device received from the electronic device. The wireless sensor node and the electronic device share a secret key with each other. The wireless sensor node encodes sensor data using the secret key, and transmits the encoded sensor data to the electronic device. The electronic device receives and decodes the encoded sensor data, using the secret key. Alternatively, if the wireless sensor node has a first encryption key and the electronic device has a second encryption key corresponding to the first encryption key, the wireless sensor node encodes sensor data using the first encryption key, and transmits the encoded sensor data to the electronic device. The electronic device is capable of decoding the received encoded sensor data, using the second encryption key. For example, the first encryption key and the second encryption key are a public key and a private key, respectively.

In operation S1440, the wireless sensor node transmits, to the electronic device, the sensor data encoded in operation S1430. The wireless sensor node may transmit, to the electronic device, its identification information and/or location information, separately or along with the sensor data. In addition, the wireless sensor node detects states of its ambient sensor nodes, and may transmit, to the electronic device, a report on the states of the ambient sensor nodes, separately or along with the sensor data. For example, the wireless sensor node identifies whether another sensor node normally works. If the other sensor node does not work normally, the wireless sensor node may report, to the electronic device, the identifier or location information on the other sensor node that does not work normally. Additionally or alternatively, the wireless sensor node detects a cause generating the malfunction of the other sensor node, and may report a value indicating the cause. In addition, the wireless sensor nodes may periodically exchange their sensed information with each other. Although the electronic device detects only part of a sensor node in a visible area, it is capable of obtaining information on the overall sensor network or information on sensor nodes out of the visible area which do not work normally. Therefore, the present disclosure can resolve the problem that a user has difficulty in detecting a correct location where an accident occurs in the real accident site, only viewing an indoor map.

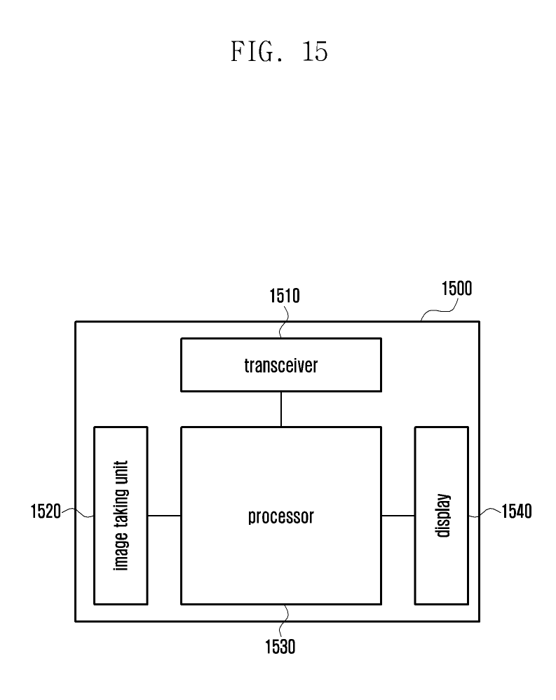

FIG. 15 is a block diagram illustrating an example configuration of an electronic device for providing AR content according to an example embodiment of the present disclosure. An electronic device 1500 described in the present disclosure may, for example, and without limitation, be wearable devices, such as glass, HMD, or the like, and mobile devices such as smartphone, or the like.

An electronic device 1500 includes a transceiver 1510 communicating with a wireless sensor node, an image taking unit (e.g., including image taking circuitry) 1520 configured to take an image and generate image information, such as, for example, and without limitation, a camera or a camcorder, a processor (e.g., including processing circuitry) 1530 for processing data of a wireless sensor node-based AR technology proposed according to the present disclosure, and a display 1540 for displaying augmented reality content. Although it is not shown in FIG. 15, the electronic device 1500 may also include application sensors for detecting its movement and location (e.g., Global Positioning System (GPS), acceleration sensor/angular velocity sensor/gyroscope). As described above in FIG. 12 and the relevant description, the transceiver 1510 is capable of receiving, from a wireless sensor node, sensed values (e.g., a temperature value, humidity value, illuminance value, etc.), an identifier for identifying a wireless sensor node, information on a location of a wireless sensor node, etc.

The image taking unit 1520 may include various image taking circuitry, such as, for example, and without limitation, a camera, a camcorder, or the like, and takes images and generates image information.

The processor 1530 may include various processing circuitry, such as, for example, and without limitation, a dedicated processor, a CPU, an application processor, an application-specific integrated circuit, or the like, and is functionally or operatively connected to the transceiver 1510 and the image taking unit 1520. The processor 1530 generates augmented reality content, based on the sensor data received by the transceiver 1510 and the image information generated by the image taking unit 1520.

The processor 1530 is capable of determining a location of a wireless sensor node, based on an identifier for identifying a wireless sensor node, received by the transceiver 1510. The processor 1530 is capable of calculating a location of the electronic device 1500, based on the strength of signals that the transceiver 1510 received from a plurality of sensor nodes. The processor 1530 is capable of updating augmented reality content based on the location and/or movement of the electronic device 1500. The processor 1530 is capable of transmitting identification information on the electronic device 1500 to request, to a specific sensor node, sensor data. If the sensor data is encoded, the processor 1530 is capable of decoding the encoded sensor data. For example, if the sensor data is encoded with a first encryption key, the processor 1530 is capable of decoding the encoded sensor data, using a second encryption key corresponding to the first encryption key. The display 1540 displays augmented reality content generated by the processor 1530.

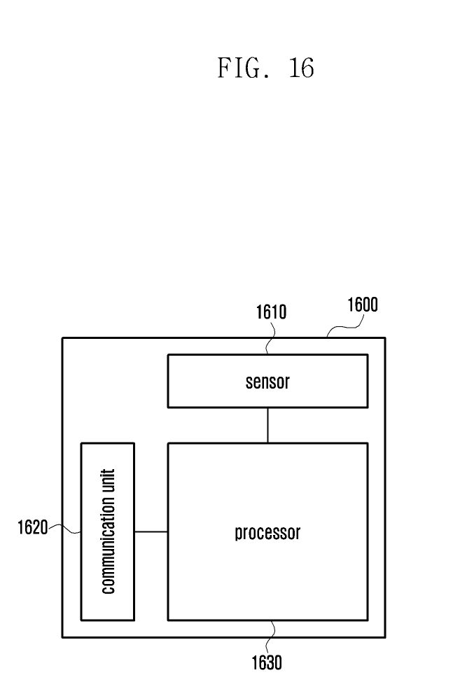

FIG. 16 is a block diagram illustrating an example configuration of a wireless sensor node according to an example embodiment of the present disclosure.

A wireless sensor node 1600 includes a sensor 1610 for performing measurement and generating sensed data, a communication unit (e.g., including communication circuitry) 1620 for communicating with an electronic device 1500 and a processor (e.g., including processing circuitry) 1630 for generating sensor data for a wireless sensor node-based AR technology proposed according to the present disclosure. The sensor 1610 performs measurement and generates sensed data. For example, the sensor 1610 may measure temperature, humidity, illuminance, etc.

The communication unit 1620 may include various communication circuitry and receives a request for sensor data from the electronic device 1500 and transmits the sensor data to the electronic device 1500. The communication unit 1620 is capable of transmitting identification information and/or location information on a wireless sensor node 1600, separately or along with sensor data. The processor 1630 may include various processing circuitry and is capable of configuring sensor data with encryption. The request for sensor data, received from the electronic device 1500, may include identification information on the electronic device 1500. The wireless sensor node 1600 may be configured in such a way as to transmit sensor data to an electronic device 1500 only if the electronic device 1500 has been authenticated. The processor 1630 may include various processing circuitry and is capable of encoding sensor data using an encryption key corresponding to the identification information.

As described above, the wireless sensor node 1600 communicates with its ambient sensor nodes and identifies states of the ambient sensor nodes. For example, the processor 1630 detects a state of another sensor node, and enables the communication unit 1620 to transmit a report on the state of the other sensor node. If the processor 1630 ascertains that another sensor node does not work normally, it detects the malfunction cause and reports, to the electronic device 1500, the cause or the identifier of the sensor node that does not work normally.

The visualization of augmented reality according to various example embodiments of the present disclosure may visualize 3D image, etc. without using markers. The visualization of augmented reality according to embodiments of the present disclosure may perform, in real-time or substantially real-time, the reception, update, and visualization of sensor information from a wireless sensor node, and also update augmented reality content based on a user's location and/or movement (e.g., turning the head). The present disclosure may also confer the access authority to only a specific electronic device, thereby providing only a specific user visualize information on a wireless sensor node. For example, the present disclosure uses a user's identification information, and thus may differently process augmented reality content provided according to users. For example, the present disclosure is capable of additionally providing: a manager with information on a repair/restoration guide with respect to the occurrence of an abnormal situation; and normal people with information on an evacuation guide or a breakdown report/reception guide.

As described above, the marker-based AR technology has required taking markers from a charge-coupled device (CCD) area of a camera, and to calculate visualization locations of objects and a reference coordinate via the 3D matrix operation. However, various example embodiments of the present disclosure are capable of calculating a reference coordinate, using signals received from a wireless sensor node, instead of using markers.

The marker-based AR technology is a static system that visualizes images and animations, taken and stored via markers. However, the wireless sensor node-based AR system according to various example embodiments of the present disclosure receives, in real-time or substantially real-time, application sensor data (e.g., temperature/humidity, illuminance, etc.) from wireless sensor nodes and dynamically visualizes the data.

As described above, the embodiments of the present disclosure are capable of processing sensed data regarding a point that is not seen (e.g., a point behind the ceiling panel, a point behind the wall, the underground, etc.), measured by wireless sensor nodes, with 3D visualization, via an augmented reality (AR) technology. The embodiments of the present disclosure are capable of checking states and information regarding points that are not seen, without performing complicated works, e.g., separation or removal of ceiling panels, walls, floors, etc.

Meanwhile, the method of displaying augmented reality content and the method of transmitting sensor data, according to various embodiments described above, may be implemented with program codes that may be stored in a non-transitory computer readable medium. The non-transitory computer-recordable medium is an apparatus-readable medium configured to semi-permanently store data. For example, the above-described various applications or programs may be stored in the non-transitory apparatus-readable medium such as a compact disc (CD), a digital versatile disc (DVD), a hard disc, a Blu-ray disc, a universal serial bus (USB), a memory card, or a read only memory (ROM), and provided.

Although various example embodiments have been illustrated and described, it will be understood that the present disclosure is not limited thereto. It will be understood by those skilled in the art that changes may be made in these embodiments without departing from the principles and spirit of the disclosure, the scope of which is defined in the claims and their equivalents.

What is claimed is:

1. A method of displaying augmented reality content in an electronic device comprising:
receiving sensor data from a specified sensor node disposed outside the electronic device;
obtaining image information from an image taking unit, the image taking unit comprising imaging circuitry;
creating augmented reality content based on the sensor data and the image information; and
displaying the augmented reality content.

2. The method of claim 1, further comprising:
receiving an identifier from the specified sensor node for use in identifying the specified sensor node; and
determining a location of the specified sensor node based on the identifier.

3. The method of claim 1, further comprising:
receiving, from the specified sensor node, information regarding a location of the specified sensor node.

4. The method of claim 1, further comprising:
determining a location of the electronic device based on strength of signals received from a plurality of wireless sensor nodes, the plurality of sensor nodes including the specified sensor node.

5. The method of claim 4, wherein the determining of the location of the electronic device comprises determining a height location of the electronic device.

6. The method of claim 1, wherein the augmented reality content is updated based on a location and a movement of the electronic device.

7. The method of claim 1, wherein creating augmented reality content comprises:
adjusting a scale of the augmented reality content, based on a distance between the electronic device and the specified sensor node.

8. The method of claim 1, further comprising:
making a request for the sensor data from the specified sensor node,
wherein the request comprises identification information of the electronic device, and wherein the sensor data are received in response to the identification information.

9. The method of claim 1, the method further comprises:
decoding the sensor data using a first encryption key,
wherein the sensor data are encoded with a second encryption key corresponding to the second encryption key.

10. The method of claim 1, further comprising:
recognizing the specified sensor node as a marker; and
wherein the augmented reality content is created, based on information derived from the sensor data, the image information and the marker.

11. An electronic device comprising:
a transceiver configured to receive sensor data from a specified sensor node disposed outside the electronic device;
an image taking unit comprising imaging circuitry configured to obtain images and to generate image information;
a processor functionally or operatively connected to the transceiver and the image taking unit; and
a display configured to display the augmented reality content,
wherein the processor is configured to create the augmented reality content based on the sensor data and the image information.

12. The electronic device of claim 11,
wherein the transceiver is configured to receive an identifier from the specified sensor node for use in identifying the specified sensor node, and
wherein the processor is configured to determine a location of the specified sensor node based on the identifier.

13. The electronic device of claim 11, wherein the transceiver is configured to receive information from the specified sensor node regarding a location of the specified sensor node.

14. The electronic device of claim 11, wherein the processor is configured to determine a location of the electronic device based on strength of signals received from a plurality of wireless sensor nodes, the plurality of sensor nodes including the specified sensor node.

15. The electronic device of claim 14, wherein the processor is configured to determine a height location of the electronic device.

16. The electronic device of claim 11, wherein the processor is configured to update the augmented reality content based on a location and a movement of the electronic device.

17. The electronic device of claim 11, wherein the processor is configured to adjust a scale of the augmented reality content, based on a distance between the electronic device and the specified sensor node.

18. The electronic device of claim 11, wherein:
the processor is configured to make a request for the sensor data from the specified sensor node;
the request comprises identification information regarding the electronic device; and
the sensor data is received in response to the identification information.

19. The electronic device of claim 11,
wherein the sensor data are encoded with a first encryption key, and
wherein the processor is configured to decode the encoded sensor data using a second encryption key corresponding to the first encryption key.

20. The electronic device of claim 11, wherein:
the image taking unit is configured to recognize the specified sensor node as a marker; and
the processor is configured to create the augmented reality content, based on information derived from the sensor data, the image information and the marker.
